(19) United States
(12) Patent Application Publication
(10) Pub. No.: US 2025/0007168 A1
(43) Pub. Date: Jan. 2, 2025

(54) DUAL-POLARIZED PATCH ANTENNA

(71) Applicant: QuantumZ Inc., Kaohsiung City (TW)

(72) Inventors: Cheng-Yi LIN, Kaohsiung City (TW); Meng-Hua TSAI, Kaohsiung City (TW); Wei-Ting LEE, Kaohsiung City (TW); Sin-Siang WANG, Kaohsiung City (TW)

(21) Appl. No.: 18/756,244

(22) Filed: Jun. 27, 2024

(30) Foreign Application Priority Data
Jun. 29, 2023 (TW) 112124337

(51) Int. Cl. H01Q 9/04; H01Q 21/24

(52) U.S. Cl. CPC H01Q 9/0414; H01Q 9/0464; H01Q 21/24

(57) ABSTRACT

A dual-polarized patch antenna includes a radiator layer, at least one middle layer disposed below the radiator layer, a ground plane layer disposed below the middle layer to provide a reference potential, and a feed layer disposed below the ground plane layer. The radiator layer includes an insulation substrate that has a top surface and a bottom surface, a base patch that is disposed on the bottom surface, and a top patch that is disposed on the top surface, and that is spaced apart from the base patch by a patch distance. The top patch includes a center portion and an annular portion that encircles and is spaced apart from the center portion. The feed layer includes a feed substrate and two feed lines. The two feed lines are arranged substantially perpendicular to each other for feeding electrical signals.

### CROSS-REFERENCE TO RELATED APPLICATION

This application claims priority to Taiwanese Invention Patent Application No. 112124337, filed on Jun. 29, 2023, the entire disclosure of which is incorporated by reference herein.

### FIELD

The disclosure relates to an antenna, and more particularly to a dual-polarized patch antenna.

### BACKGROUND

A microstrip patch antenna is fabricated by forming a thin conductive structure on a substrate. By altering a geometric configuration of the conductive structure, the microstrip patch antenna may be configured to meet specific requirements such as resonance, bandwidth, gain, etc., to conform to specifications of various products. In addition, microstrip patch antennas offer advantages such as lower manufacturing costs, lighter weights and smaller sizes, making them suitable for consumer electronics such as mobile phones, tablets, and smartwatches.

Continuous efforts are made to further miniaturize and simplify microstrip patch antennas structures. These adjustments are intended for the microstrip patch antennas to meet ever more critical requirements such as directivity, resonance, wave propagation velocity, bandwidth, etc.

### SUMMARY

The disclosure is to provide a dual-polarized patch antenna that achieves significant improvement to the prior art.

According to the disclosure, the dual-polarized patch antenna includes a radiator layer, at least one middle layer disposed below the radiator layer, a ground plane layer disposed below the at least one middle layer to provide a reference potential, and a feed layer disposed below the ground plane layer.

The radiator layer includes an insulation substrate that has a top surface and a bottom surface on opposite sides of the insulation substrate, a base patch including an electrically conductive material and disposed on the bottom surface, and a top patch including an electrically conductive material and disposed on the top surface and spaced apart from the base patch by a patch distance along a direction from the top surface to the bottom surface. The top patch includes a center portion aligned with the base patch, and an annular portion that encircles and that is spaced apart from the center portion.

The feed layer includes a feed substrate, two feed lines, and two conductor rods. The feed substrate has a top side attached to the ground plane layer and a bottom side opposite to the top side. The two feed lines are disposed on the bottom side of the feed substrate and are substantially perpendicular to each other for feeding electrical signals. The two conductor rods are electrically connected between the two feed lines and the base patch.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is an exploded perspective view of a dual-polarized patch antenna according to an embodiment of the present disclosure.

FIG. 2 is a top view of a radiator layer according to an embodiment of the present disclosure.

FIG. 3 is a bottom view of a feed layer according to an embodiment of the present disclosure.

FIG. 4 is a fragmentary sectional view of the dual-polarized patch antenna according to an embodiment of the present disclosure.

FIG. 5 illustrates measurement and simulation of input return loss for first polarization according to an embodiment of the present disclosure.

FIG. 6 illustrates measurement and simulation of input return loss of second polarization according to an embodiment of the present disclosure.

FIG. 7 illustrates measurement and simulation of isolation according to an embodiment of the present disclosure.

FIG. 8 illustrates a radiation pattern of a horizontal polarization according to an embodiment of the present disclosure.

FIG. 9 illustrates a radiation pattern of a vertical polarization according to an embodiment of the present disclosure.

### DETAILED DESCRIPTION

It should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

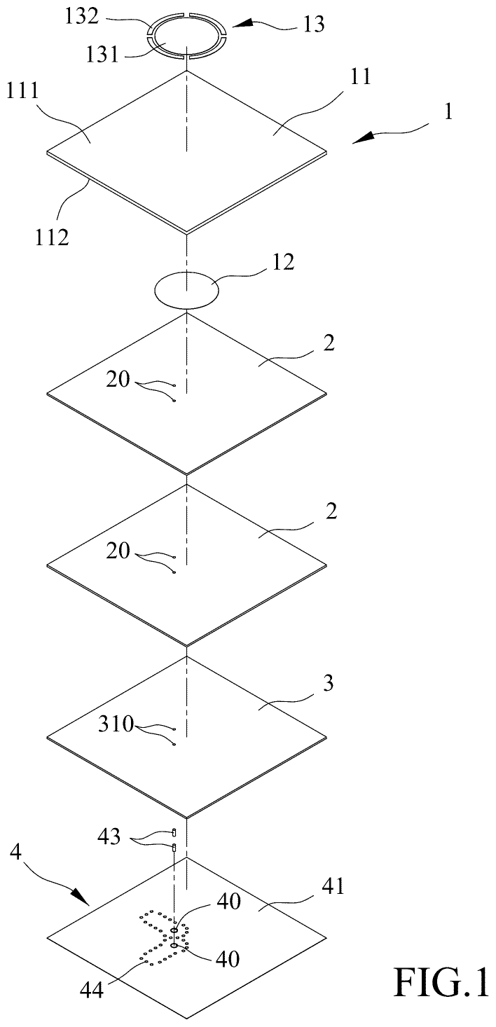

Referring to FIG. 1, a dual-polarized patch antenna according to an embodiment of this disclosure includes a radiator layer 1, at least one middle layer 2 disposed below the radiator layer 1 (two middle layers 2 are exemplarily shown), a ground plane layer 3 disposed below the two middle layers 2 to provide a reference potential, and a feed layer 4 disposed below the ground plane layer 3. The radiator layer 1, the two middle layers 2, the ground plane layer 3 and the feed layer 4 form a stacked structure. Each layer has a thickness of approximately 200 micrometers (μm) so as to enable this embodiment to meet a low profile requirement when the layers are stacked. In some embodiments, each layer has a thickness of about 100 μm except for the radiator layer 1. This embodiment is designed to enhance communication of the 5^{th} generation mobile networks (5G), and to focus on a frequency band of n257 for the 5G New Radio (NR), which covers a frequency range of 26.5 to 29.5 Gigahertz (GHz). In some embodiments, the dual-polarized patch antenna supports a 3 GHz bandwidth and may be used in combination with beamforming techniques.

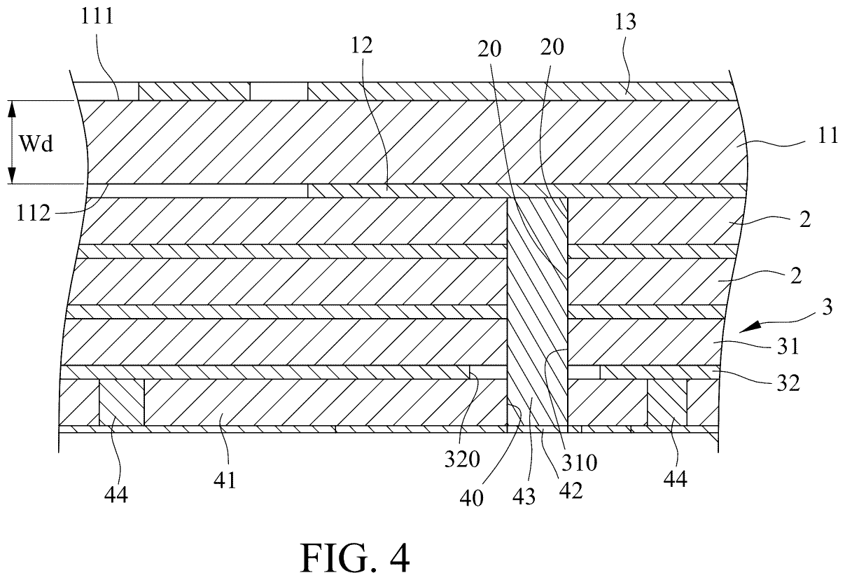

Referring to FIGS. 1 and 4, the radiator layer 1 includes an insulation substrate 11 that has a top surface 111 and a bottom surface 112 on opposite sides of the insulation substrate 11, a base patch 12 that is disposed on the bottom surface 112 and that includes an electrically conductive material, and a top patch 13 that is disposed on the top surface 111, that includes an electrically conductive material, and that is spaced apart from the base patch 12 by a patch distance (Wd) along a direction from the top surface 111 to the bottom surface 112. The insulation substrate 11 includes a liquid-crystal polymer (LCP) material that makes the insulation substrate 11 flexible. This property of the insulation substrate 11 provides this embodiment with an advantage of being easier to design and manufacture alongside other parts of a product. By adjusting the patch distance (Wd), a parasitic capacitance between the top patch 13 and the base patch 12 may be adjusted, and an operating frequency band of this embodiment may be altered. In this embodiment, the patch distance (Wd) is configured to be about 200 μm. This arrangement allows this embodiment to be able to operate in the frequency band of n257 for the 5G NR. Other bands are also possible with different patch distance (Wd) configurations.

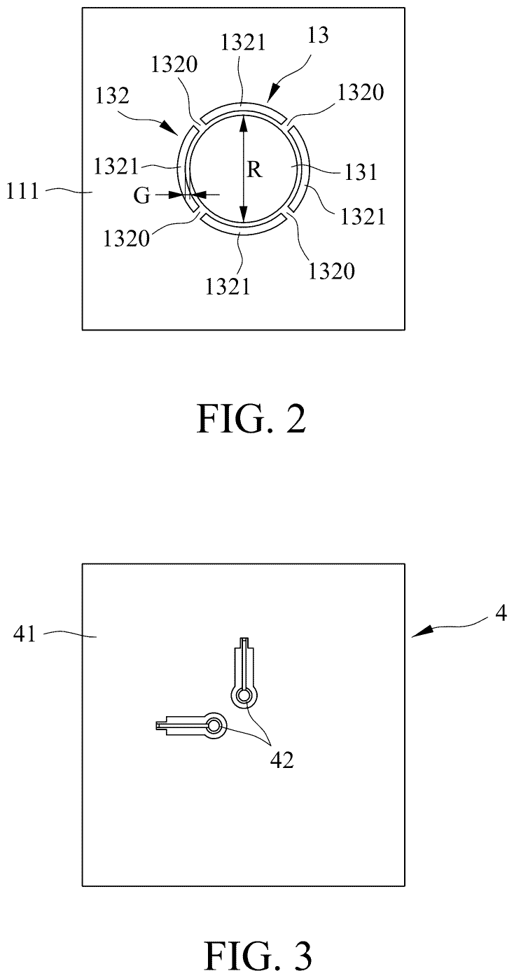

The electrically conductive material of the base patch 12 and the electrically conductive material of the top patch 13 include a metal, such as copper or aluminum. The base patch 12 is circular in shape. The base patch 12 and the top patch 13 are on the opposite sides of the insulation substrate 11. Referring to FIGS. 1 and 2, the top patch 13 includes a center portion 131 and an annular portion 132 that encircles and is spaced apart from the center portion 131 along a radial direction by a void (G). A projection of the center portion 131 along the direction onto the bottom surface 112 is aligned with the base patch 12 that is circular in shape. That is to say, the center portion 131 of the top patch 13 is circular in shape, and is aligned with the base patch 12 along the direction from the top surface 111 to the bottom surface 112. The annular portion 132 of the top patch 13 includes a plurality of segments 1321, any adjacent two of which are separated from each other by a spacing 1320. In this embodiment, a number of the segments 1321 is four. Each of the four segments 1321 of the annular portion 132 has a width ranging from 0.030λ to 0.040λ and a length ranging from 0.40λ to 0.50λ, where λ represents a wavelength of a signal of the dual-polarized patch antenna. In this embodiment, the center portion 131 has a diameter (R) which is at least half of the wavelength of the signal of the dual-polarized patch antenna (i.e., 0.5λ) in order for the dual polarized patch antenna to operate at the 28 GHz band. Each of the four segments 1321 of the annular portion 132 has the width of 0.034λ and the length of 0.44λ. The void (G) between the center portion 131 and the annular portion 132 is 0.024λ. These arrangements of the annular portion 132 may improve a resonance mode of the top patch 13 when the top patch 13 is resonating.

It should be noted that the annular portion 132 is disposed around a periphery of the center portion 131. The center portion 131 serves as a radiating component, allowing the dual-polarized patch antenna to operate within a frequency range of 26 GHz to 30 GHz. The annular portion 132 is divided into the four segments 1321 by four spacings 1320. Each of the four spacings 1320 ranges from 0.045λ to 0.050λ. In one embodiment, each of the four spacings 1320 is 0.047λ. The four spacings 1320 and the void (G) may introduce parasitic capacitance, thereby potentially balancing parasitic inductance introduced by the four segments 1321 of the annular portion 132 so that an imaginary part of impedance related to the annular portion 132 may approach zero. In this way, optimal resonance conditions may be achieved, which may contribute to a broadening of a radiating bandwidth of the dual-polarized patch antenna. The center portion 131 and the annular portion 132 are configured to fulfil a formula

$$\frac{spacing ( 1320 )}{G} > \frac{1}{2 \sqrt{{D}_{k}}} ,$$

where G represents the void, Dₖ represents a dielectric coefficient of the insulation substrate 11.

Referring to FIGS. 1 and 4, the two middle layers 2 are fabricated by forming metal structures on LCP substrates. The two middle layers 2 may be adjusted to accommodate design requirements of the radiator layer 1 in order to meet frequency and bandwidth requirements of the dual-polarized patch antenna. The two middle layers 2 each has two through holes 20 that are spaced apart from each other. The two through holes 20 of one of the two middle layers 2 (hereinafter referred to as “an upper middle layer 2”) that is adjacent to the base patch 12 are positioned to respectively align with the two through holes 20 of the other one of the two middle layers 2 (hereinafter referred to as “a lower middle layer 2”) that is adjacent to the ground plane layer 3. When the two middle layers 2 are stacked between the base patch 12 and the ground plane layer 3, the two through holes 20 of the upper middle layer 2 and the two through holes 20 of the lower middle layer 2 together form two holes that extend from the ground plane layer 3 to the base patch 12.

The ground plane layer 3 is used for a ground connection so as to provide a reference potential for a main signal that is transmitted from the feed layer 4 to the radiator layer 1. The ground plane layer 3 includes a ground substrate 31 and a ground plane 32. The ground substrate 31 has a top side facing the lower middle layer 2 and a bottom side opposite to the top side of the ground substrate 31, and two ground substrate holes 310 extending from the bottom side of the ground substrate 31 to the top side of the ground substrate 31, being spaced apart from each other, and being positioned to respectively align with the two through holes 20 of the lower middle layer 2. The ground plane 32 has a top side that is attached to the ground substrate 31 and a bottom side that is opposite to the top side of the ground plane 32, and two ground plane holes 320 (only one is shown in FIG. 4) that extend from the bottom side of the ground plane 32 to the top side of the ground plane 32, that are spaced apart from each other, and that are positioned to respectively align with the two ground substrate holes 310 of the ground substrate 31. In some embodiments, the ground substrate 31 is an LCP substrate, and the ground plane 32 includes a conductive material, such as copper or aluminum.

Referring to FIGS. 1, 3, and 4, the feed layer 4 includes a feed substrate 41 and two feed lines 42. The feed substrate 41 has a top side attached to the ground plane layer 3 and a bottom side opposite to the top side of the feed substrate 41. The two feed lines 42 are disposed on the bottom side of the feed substrate 41, are arranged substantially perpendicular to each other, and are used for feeding electrical signals. The feed substrate 41 has two feed holes 40 that extend from the bottom side of the feed substrate 41 to the top side of the feed substrate 41. On the bottom side of the feed substrate 41, the two feed holes 40 are positioned to respectively align with the two feed lines 42, and on the top side of the feed substrate 41, the two feed holes 40 are positioned to respectively align with the two ground plane holes 320 of the ground plane 32. The feed layer 4 further includes two conductor rods 43 (only one is shown in FIG. 4) that are electrically connected between the two feed lines 42 and the base patch 12 for feeding electrical signals from the two feed lines 42 to the base patch 12 of the radiator layer 1. In specific, two ends of the two conductor rods 43 are connected to the two feed lines 42 respectively, and the other two ends on opposite sides of the two conductor rods 43 are connected to the base patch 12 by respectively going through the two feed holes 40, the two ground plane holes 320, the two ground substrate holes 310, the two through holes 20 of the lower middle layer 2, and the two through holes 20 of the upper middle layer 2. The two feed lines 42 are able to transmit or receive signals with two different polarization directions. In this embodiment, signals with horizontal and vertical polarization directions are generated or received. However, the polarization directions of signals transmitted or received by the two feed lines 42 may vary as long as the polarization directions remain orthogonal to each other. For example, the signals may have polarization directions at 45 degrees and 135 degrees, or −45 degrees and 45 degrees with respect to a reference plane of 0 degrees.

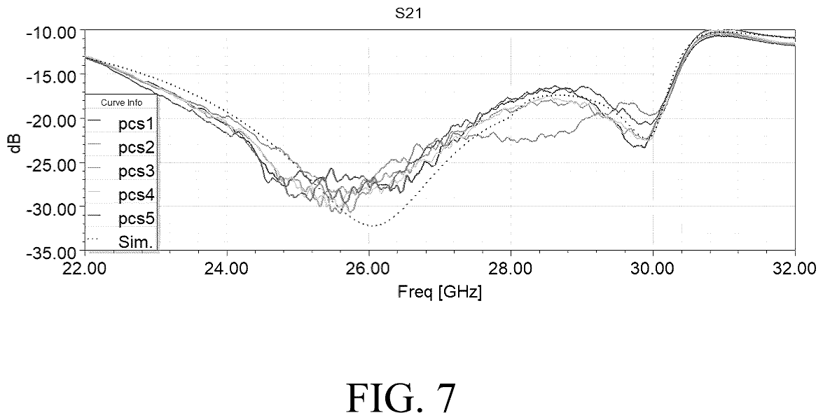

Referring to FIGS. 1 and 4, it should be noted that, the feed layer 4 further includes an isolation unit 44. The isolation unit 44 includes a plurality of isolation rods that are spaced apart from each other, and that are arranged to surround each one of the two feed lines 42 for blocking electromagnetic waves. The isolation unit 44 is adapted to maintain a signal independence of each one of the two feed lines 42 and to enhance an isolation level of the two feed lines 42. The isolation unit 44 prevents signals from one of the two feed lines 42 from coupling or interfering with signals from another one of the two feed lines 42, thereby reducing return loss of the signals. Referring to FIG. 7, results measured from five samples (labelled as pcs 1, pcs 2, pcs 3, pcs 4 and pcs 5) are close to a simulated result (labelled as Sim.), and the isolation level of the two feed lines 42 within a frequency band of 22.4 GHz to 30.1 GHz is less than −15 dB, indicating that the two feed lines 42 are well isolated, so that the dual-polarized patch antenna has good directivity.

As mentioned earlier, the dual-polarized patch antenna according to the embodiment of this disclosure is a half-wave patch antenna. When the dual-polarized patch antenna is operated, the base patch 12 and the ground plane layer 3 may resonate to operate in a first resonance mode. The base patch 12 then resonates with the top patch 13 to operate in a second resonance mode with a bandwidth that is wider than a bandwidth of the first resonance mode. With this arrangement, a required operating bandwidth may be achieved with reduced number of layers that would otherwise be necessary, thereby reducing an overall thickness of the dual-polarized patch antenna.

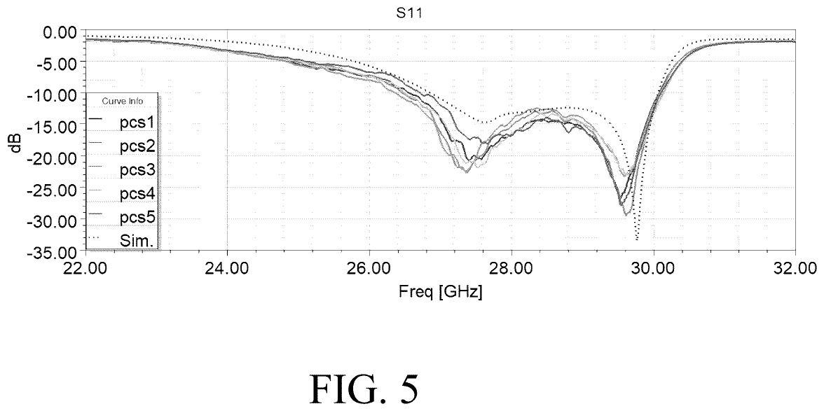

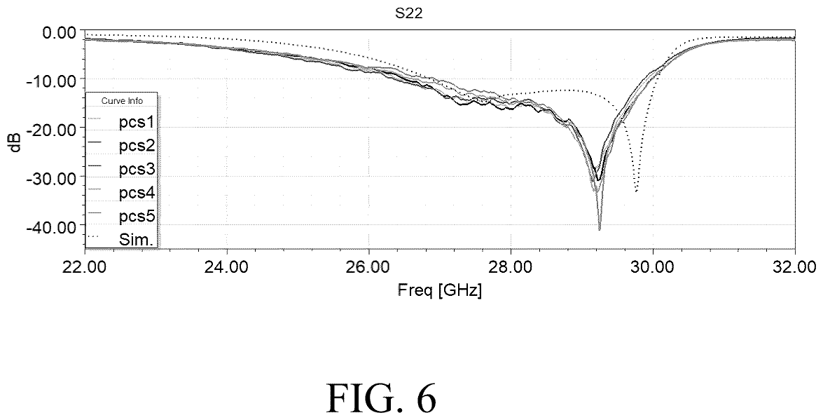

Referring to FIG. 5, a comparison between a simulated plot and actual operating plots of five samples of this embodiment in terms of input return loss of the first polarization (S11) is shown. A frequency range that corresponds to the input return loss (S11) of less than −10 dB for this embodiment is between 26.34 GHz and 30.14 GHz, and is close to a frequency range of 26.5 GHz to 30.14 GHz for the simulated plot. Referring to FIG. 6, a comparison between a simulated plot and actual operating plots of five samples of this embodiment in terms of input return loss of the second polarization (S22) is shown. A frequency range that corresponds to the input return loss (S22) of less than −10 dB for this embodiment is between 26.34 GHz and 30.11 GHz, and is close to the frequency range of 26.5 GHz to 30.14 GHz for the simulated plot. As shown in FIGS. 5 and 6, the measured results of all five samples are close to each other and close to the simulated plot, indicating good reproducibility and radiation efficiency of this embodiment.

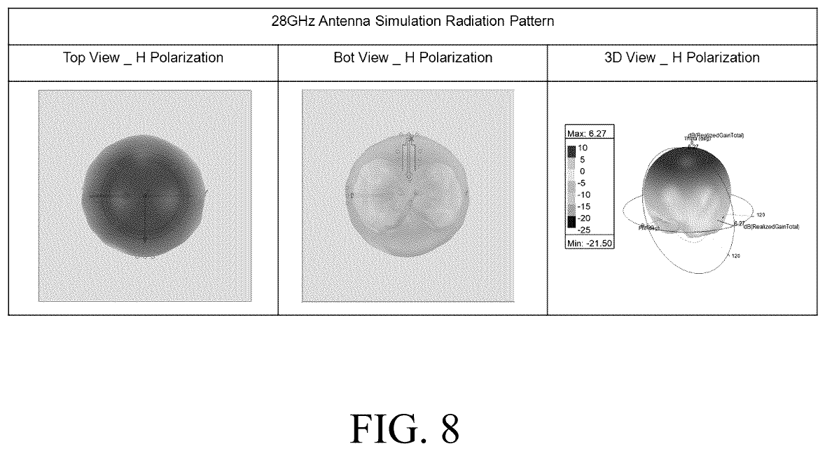

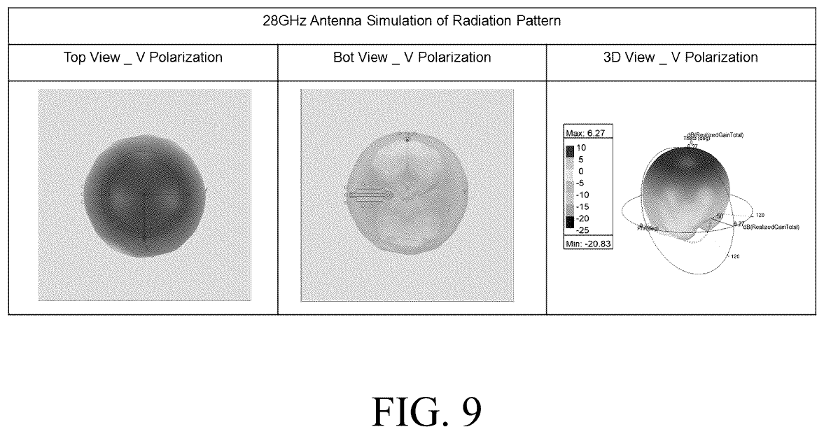

Referring to FIGS. 2 to 3, and 8 to 9, in this embodiment, the dual-polarized patch antenna is a directional antenna, having a gain of approximately 6.27 dB. The gain may be increased by expanding this embodiment into an N*N array antenna, and the dual-polarized patch antenna is applicable to the beamforming and Butler Matrix systems. In the beamforming system, an active Integrated Circuit (IC) is employed to directly adjust an antenna radiation pattern, allowing for rotation of the antenna radiation pattern, while in the Butler Matrix system, a phase is passively adjusted through wiring on a circuit, leading to the rotation of the antenna radiation pattern. In each of FIGS. 8 and 9, a top view, a bottom view, and a 3-dimensional representation of the antenna radiation pattern with respect to a respective one of the two polarization directions collectively illustrate a fairly circular beam, showing that this embodiment performs well in gain, bandwidth, and other requirements.

In sum, through the design of the top patch 13 and the presence of the base patch 12 for improving resonance modes, and with the arrangements of the two middle layers 2, the ground plane layer 3 and the feed layer 4, the dual-polarized patch antenna according to this disclosure is able to meet the requirements of frequency band and bandwidth specifications.

For the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A dual-polarized patch antenna, comprising:
a radiator layer including an insulation substrate that has a top surface and a bottom surface on opposite sides of said insulation substrate, a base patch including an electrically conductive material and being disposed on said bottom surface, and a top patch including an electrically conductive material and being disposed on said top surface and spaced apart from said base patch by a patch distance along a direction from said top surface to said bottom surface, said top patch further including a center portion aligned with said base patch, and an annular portion encircling and being spaced apart from said center portion;
at least one middle layer disposed below said radiator layer;
a ground plane layer disposed below said at least one middle layer to provide a reference potential; and
a feed layer disposed below said ground plane layer, and including a feed substrate, two feed lines, and two conductor rods, wherein said feed substrate has a top side attached to said ground plane layer and a bottom side opposite to said top side, said two feed lines are disposed on said bottom side of said feed substrate and are substantially perpendicular to each other for feeding electrical signals, and said two conductor rods are electrically connected between said two feed lines and said base patch.

2. The dual-polarized patch antenna as claimed in claim 1, wherein said annular portion of said top patch includes a plurality of segments, any adjacent two of which are separated by a spacing; and
wherein said annular portion is spaced apart from said center portion along a radial distance by a void, and fulfils a formula
$$\frac{spacing}{G} > \frac{1}{2 \sqrt{{D}_{k}}} ,$$
where Dₖ is a dielectric coefficient of said insulation substrate.

3. The dual-polarized patch antenna as claimed in claim 2, wherein said plurality of segments include four segments, and said annular portion is divided into said four segments by four spacings.

4. The dual-polarized patch antenna as claimed in claim 3, wherein each of said four spacings ranges from 0.045λ to 0.050λ, where λ represents a wavelength of a signal of said dual-polarized patch antenna.

5. The dual-polarized patch antenna as claimed in claim 4, wherein each of said four segments of said annular portion has a width ranging from 0.030λ to 0.040λ and a length ranging from 0.40λ to 0.50λ.

6. The dual-polarized patch antenna as claimed in claim 1, wherein both said center portion of said top patch and said base patch are circular in shape.

7. The dual-polarized patch antenna as claimed in claim 1, wherein said center portion serves as a radiating component, allowing said dual-polarized patch antenna to operate within a frequency range of 26 GHz to 30 GHz.

8. The dual-polarized patch antenna as claimed in claim 1, wherein said insulation substrate includes a liquid-crystal polymer (LCP) material.

9. The dual-polarized patch antenna as claimed in claim 1, wherein each of said electrically conductive material of said base patch and said electrically conductive material of said top patch includes a metal.

10. The dual-polarized patch antenna as claimed in claim 1, wherein said at least one middle layer includes two middle layers.
